(19) United States
(12) Patent Application Publication
(10) Pub. No.: US 2012/0286962 A1
(43) Pub. Date: Nov. 15, 2012

(54) INPUT DEVICE AND INDICATOR THEREOF

(75) Inventors: ER-HAO CHEN, NEW TAIPEI CITY (TW); TAO-CHENG YEN, NEW TAIPEI CITY (TW); CHIN-FA WU, NEW TAIPEI CITY (TW)

(73) Assignees: LITE-ON TECHNOLOGY CORPORATION, TAIPEI CITY (TW); SILITEK ELECTRONIC (GUANGZHOU) CO., LTD., GUANGZHOU (CN)

(21) Appl. No.: 13/251,318

(22) Filed: Oct. 3, 2011

(30) Foreign Application Priority Data
May 10, 2011 (CN) 201120145193.1

(51) Int. Cl. G08B 21/00

(52) U.S. Cl. 340/660; 340/664

(57) ABSTRACT

An input device including a control unit and an indicator is illustrated. The indicator further includes an indicating unit and a driving unit. The control unit is configured to receive a control signal and trigger an indication voltage according to the control signal to output an indication current to the driving unit. The indicating unit has multiple indication faces. The driving unit is electronically connected with the control unit and is coupled to the indicating unit, and is used to drive the indicating unit to switch to one of the multiple indication faces based on the direction of the received indication current.

### BACKGROUND OF THE INVENTION

1. Field of the Invention

The present invention relates to an electronic device; in particular, to an input device of an electronic device and an indicator of the input device.

2. Description of Related Art

Many input devices have lights or similar indicators for users to distinguish different input modes of the devices. Lights corresponding to ‘Caps Lock’ key, ‘Num Lock’ key, and ‘Scroll Lock’ key on a computer keyboard are one of the examples. Another instance is a warning for low battery of a multi-media presentation controller that could display a warning sign on the screen of the controller when the power is lower than a threshold value.

Input devices needs to provide a few milliampere of currents constantly for maintaining the indicating function enabled, such as keep the lights luminant or keep the screen showing low power information, which increases the power consumption of the input device. The power of the input device might be exhausted quickly when the device is powered by batteries. Furthermore, total cost and the complexity of IC design of the input device might be increased when the indicating lights are light emitting diodes or the display is a liquid crystal display.

### SUMMARY OF THE INVENTION

The present invention discloses an input device including a control unit and an indicator. The indicator further includes an indicating unit and a driving unit. The control unit is configured for receiving a control signal and triggering an indication voltage on receipt of the control signal and outputting an indication current. The indicating unit has multiple indication faces. The driving unit electronically connected to the control unit and is coupled to the indicating unit, and drives the indicating unit switching to one of the multiple indication faces according to a direction of the outputted indication current.

Moreover, the present invention discloses an indicator of an input device including a control unit for triggering an indication voltage and outputting an indication current. The indicator includes an indicating unit and a driving unit. The indicating unit has multiple indication faces. The driving unit electronically connected with the control unit and coupled to the indicating unit. The indicating unit is driven by the driving unit and switched to one of the multiple indication faces in accordance with the direction of the indication current outputted by the control unit.

As disclosed in the above-mentioned embodiments, the input device and the indicator of the present invention may point out different operation modes of input devices while consuming only a small amount of electricity shortly from the voltages triggered by the control unit. The power consumption of the input device may be reduced, and the operation time of the input device may be extended according to the present invention. Moreover, the IC design for the input device and the indicator disclosed in the embodiment of the present invention is simple and low cost.

In order to further the understanding regarding the present invention, the following embodiments are provided along with illustrations to facilitate the disclosure of the present invention.

### BRIEF DESCRIPTION OF THE DRAWINGS

FIG. 1 shows a circuit diagram of an input device according to an embodiment of the present invention;

FIG. 2 shows a circuit diagram of an indicator according to an embodiment of the present invention;

FIG. 3 shows a perspective diagram of an input device according to an embodiment of the present invention;

FIG. 4 shows a circuit diagram of an input device according to another embodiment of the present invention;

FIG. 5 shows a perspective diagram of an input device according to still another embodiment of the present invention;

FIGS. 6A and 6B show perspective diagrams of an indicator according to another embodiment of the present invention; and

FIGS. 7A and 7B show perspective diagrams of an indicator according to still another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

Embodiment of an Input Device—Indication to Operation Modes

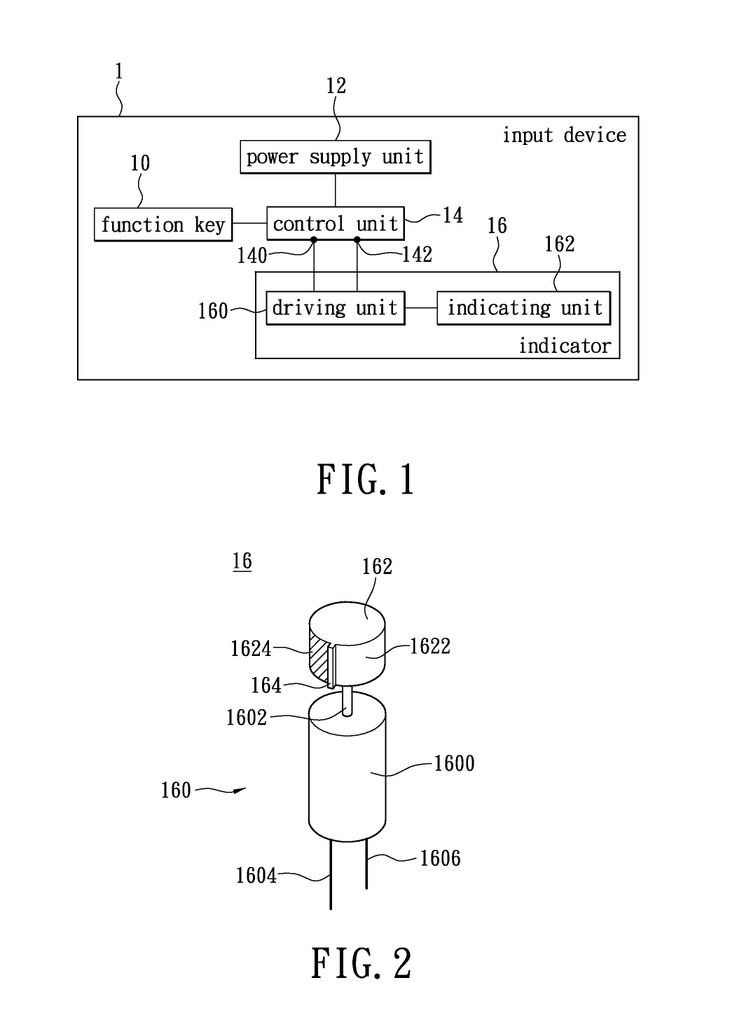

Refer to FIG. 1, which illustrates a circuit diagram of an input device according to an embodiment of the present invention. The input device 1 of this embodiment includes a function key 10, a power supply unit 12, a control unit 14, and an indicator 16. The control unit 14 further includes input/output (I/O) pins 140 and 142, and the indicator 16 includes a driving unit 160 and an indicating unit 162. The function key 10, the power supply unit 12 and the driving unit 160 of the indicator 16 are coupled to the control unit 14, respectively. The indicating unit 162 is coupled to the driving unit 160.

The input device 1 of the embodiment may be a cord or a cordless keyboard applicable to an electronic computation device. The keyboard may have a plurality of letter keys each corresponding to an English or/and numeric letter, and a plurality of function keys 10. The function key 10 may be a Caps Lock key, a Num Lock key, or a Scroll Lock key. The function key 10 is configured to control operation modes of the input device 1. Some specific input functions may be enabled or disabled via pressing the function key 10. For example, while the Caps Lock key used to control the appearance type of English letters is pressed and a capital locking function is enabled, a display (not shown) of the input device may display an upper case corresponding to a pressed letter key. On the other hand, when the Caps Lock key is pressed again and the capital locking function is disabled, the letter displayed on the display is a lower case corresponding to the pressed letter key. The Num Lock key is configured to control operation modes of a plurality of number keys on a number key pad that is usually allocated at right side of the keyboard. When the Num Lock key is pressed and a number locking function is enabled, the display may show numbers based on the number keys pressed. When the Num Lock key is pressed again and the number locking function is disabled, the number keys may serve as direction designating keys. Meanwhile, the Scroll Lock key is used to control scrolling modes when executing a computer application.

The power supply unit 12 may be utility power or batteries depending on whether the input device 1 is a cord or a cordless device. When the input device 1 is a cord keyboard, the keyboard may receive power through cable from the computation device (e.g. a computer host) connecting to the utility power. When the input device 1 is a cordless keyboard, the power supply unit 12 may be a battery which independently provides electricity for the whole input device 1.

The control unit 14 may be a micro controller of the keyboard. The control unit 14 not only may receive the power supplied by the power supply unit 12 to detect scan codes of any pressed key on the keyboard, but may receive a control signal generated by the pressed function key 10 to control the indicator 16 for indicating the changes of the operation modes of the input device 1. Detailed descriptions of the control unit 14 would be revealed in the following paragraphs.

The driving unit 160 may electronically connect with the two I/O pins 140 and 142 of the control unit 14. The indicating unit 162 of the present embodiment may mechanically connect with the driving unit 160. The surface of the indicating unit 162 may be divided into multiple indication faces for indicating different input modes. For instance, a circular indicating unit may be covered by two different colors on each 180 degrees of the surface respectively, such as a brighter color covering on the first 180 degree and a darker color covering on the other 180 degree, therefore the indication unit 162 may have two indication faces. The circular indicating unit may have three indication faces by covering three different colors on each 120 degrees of the surface, and so on. The indicating unit 162 may be driven by the connected driving unit 160 and then change the indication faces that are configured to indicate one of the input modes of the corresponding function key 10.

When receiving the control signal generated by the pressed function key 10, the control unit 14 may determine the input mode corresponding to the pressed function key 10 is changed via the control signal. For example, the control unit 14 may identify that the capital locking function is enabled via the control signal generated by the Caps Lock key. The control unit 14 may then generate a corresponding indication voltage, such as a forward voltage, based on the received control signal and the identified input mode. The control unit 14 further outputs a positive current and a negative current through the I/O pins 140 and 142, respectively, to make a directional indication current, such as a forward current, to the driving unit 160 of the indicator 16 corresponding to the Caps Lock key. The driving unit 160 may be motivated according to the indication current and then drive the indication unit 162 to synchronously move to change the indication faces.

When the function key 10 is pressed again, the control unit 14 may also receive the control signal generated by the function key 10 and identify the enabled input mode is currently disabled, and then generate another indication voltage. The newly generated indication voltage may be a reversed voltage compares to the voltage generated when the input mode is enabled, so as to form a reversed current that transmits via the I/O pins 140 and 142. The driving unit 162 may be motivated reversely, and drive the indication unit 162 to another indication face.

Therefore, when a user presses the Caps Lock key to lock the English letters output to the display are upper cases, the indicator 16 corresponding to the Caps Lock key would be able to show one of the indication faces, such as the surface covered by brighter color indicating the enablement of the capital locking function. On the other hand, when the user presses the same Caps Lock key again, the indicator 16 may switch to another indication face, such as the surface with darker color indicating the disablement of the capital locking function.

According to the above disclosed embodiment, the indicator 16 would not be necessary to continuously receive power for retaining the same indication face even when the input mode is continuously enabled. The input device 1 may need the power supply unit 12 to provide power to the driving unit 160 only when the driving unit 162 is driving the indication unit 162 to change the indication faces. Since the change or switch of the indication faces is completed, the power supply unit 12 would not have to provide power to the driving unit 160 until next changing or switching requirement is occurred. Therefore, based on the present embodiment, enablement or disablement of the input mode of a function key 10 on the input device 1 may be accurately indicated, meanwhile, the power consumption may be reduced and the operation time of the input device 1 may also be extended.

Embodiment of an Indicator

Please refer to FIG. 2 which illustrates one embodiment of the indicators adaptable to the input device shown in FIG. 1. The indicator 16 in FIG. 2 includes a driving unit 160, an indicating unit 162, and a brake 164. The driving unit 160 may be a motor including a body 1600, a rotatable shaft 1602, and power cables 1604 and 1606. The motor may be a stepping motor or an induction motor. The power cables 1604 and 1606 may connect with the I/O pins 140 and 142 of the control unit 14 shown in FIG. 1, respectively, for electronically connecting to the control unit 14 and receiving the power from exterior of the indicator 16.

The indicating unit 162 may be mounted on the top of the rotatable shaft 1602. For example, the indicating unit 162 could be a turntable or a ring surrounding and fixed on the rotatable shaft 1602. The ring is taken as a specific example of the indicating unit 162 in the following disclosure. The surface of the ring may be covered with different colors to represent different indication faces, and each indication face is used to designate an input mode of the function key 10 that the indicator 16 corresponds to. Take an enabled capital locking mode when pressing the Caps Lock key once and a disabled capital locking mode when pressing the Caps Lock key again as instance, the surface of the ring may be divided into a first indication face 1622 and a second indication face 1624, wherein each of the indication face covers 180 degrees of the surface and represents the enabled capital locking mode and the disabled capital locking mode, respectively. The surface of the ring may be allocated to surface a window (not shown in FIG. 2) of the of the input device, thus the user would be able to know the corresponding input mode through observing one of the indication face 1622 and 1624 in the window. The relation between the window and the indicating unit would be introduced in following paragraphs.

Please refer to FIGS. 1 and 2, when receiving the control signal of the function key 10 and identifying the enablement or disablement of the input mode, the control unit 14 may generate a corresponding indication voltage and the indication current having the same direction to trigger the motor to rotate in accordance with the direction of the indication current, and then causes the ring mounted on the rotatable shaft 1602 synchronously rotate.

For example, when the input mode is identified enabled, the control unit 14 generates an indication voltage (e.g. +5v for a cord keyboard and +3 for a cordless keyboard or a multi-media presenting controller, but not limited) so that the positive current and the negative current is transmitted though the I/O pins 140 and 142 respectively to form a forward current to the driving unit 160. The driving unit 160 may rotate toward a first direction according to the forward current and drive the ring to the position showing the first indication face 1622, such as a bright color surface. On the opposite side, when the control unit 14 determines the input mode is disabled, the indication voltage opposite to the enabled input mode is generated (e.g. −5v or −3v) and transmitted a negative current and a positive current through the I/O pins 140 and 142 respectively to form a reverse current. The driving unit 160 is triggered to rotate toward a second direction that is a reverse direction compares to the first direction. The ring is then driven by the driving unit 160 and rotates to the position showing the second indication face 1624, such as a dark color surface. Based on the above-mentioned approach that changes the indication face in turn, when the input mode controlled by the function key 10 is enabled, the indicator 16 shows the first indication face 1622 with bright color, and when the input mode is disabled, the indicator 16 shows the second indication face 1624 with dark color, so that the user would be clearly informed with the status of the input mode of the input device 1.

It is worth mentioning that a brake 164 (reference is made to FIG. 2) may be placed at the border shared by the first indication face 1622 and the second indication face 1624 for accurately shows the indication face corresponding to the enablement or disablement of the input mode. The brake 164 may be a scrap of plastic protruded from the surface of the ring, or other materials capable of stop the ring to rotate. While the brake 164 is obstructed by one edge of the window during the indicator 16 rotating, the driving unit 160 may stop rotating then. In other words, when the indication unit 162 rotates to a brake point and stops rotating, the power provided to the driving unit 160 could be cut off and no further power would be consumed for showing the indication face. When the driving unit 160 is again triggered by the control unit 14 and starts to reversely rotate, the ring may also synchronously rotate with the driving unit 160 until the brake 164 is obstructed by the other edge of the window, therefore the other indication face may surface the window and provide the indication information. The position of the brake 164 shown in FIG. 2 is simply one of the many places that may locate the brake 164. The brake 164 could be placed in other appropriate positions on the indicator 16 for stop the indicator 16 rotating, such as placed on the body 1600 or placed between the body 1600 and the ring, and located between the border of the first indication face 1622 and the second indication face 1624.

Also worth mentioning, the indicating unit 162 of the above-mentioned embodiment is divided into two surfaces though, the number of the indication faces may be divided into more than two according to the numbers of modes needed to be indicated. For instance, the driving unit 160 may be implemented by a stepping motor which could calculate the rotating angles. The brake 164 may be omitted, and the number of the indication faces may increase when using a stepping motor as the driving unit 160.

Embodiment of an Input Device—Cordless Keyboard

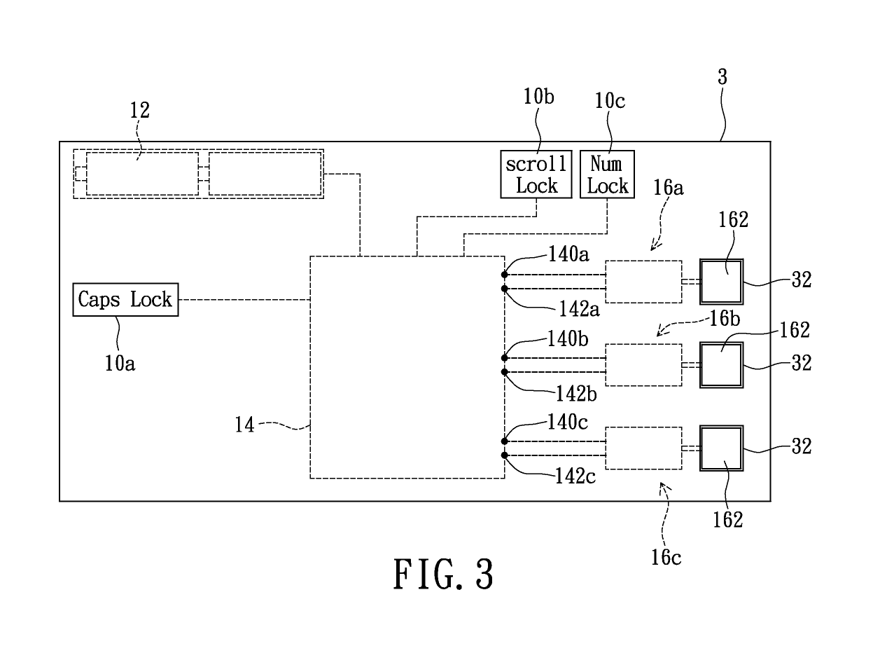

The following paragraph is used to introduce a specific example of input device and indicator as revealed in FIGS. 1 and 2. Reference is now made to FIG. 3, which illustrates a perspective diagram of said input device according to the specific example. The input device in FIG. 3 is a cordless keyboard 3 powered by a battery as the power supply unit 12. A plurality of keys is configured on the cordless keyboard including multiple English letter keys, numeric letter keys, and multiple function keys used to control input modes of the cordless keyboard 3, such as a Caps Lock key 10a, a Num Lock key 10b, and a Scroll Lock key 10c. For clarity and ease of observation, the keys of the cordless keyboard 3 shown in FIG. 3 include only said Caps Lock key 10a, said Num Lock key 10b, and said Scroll Lock key 10c, other keys like English letter keys are not shown in FIG. 3.

A control unit 14 is embedded in the cordless keyboard 3, which is electronically connected with the plurality of keys and the scan lines. The control unit 14 is used to detect the function key being pressed and receive a control signal transmitted by the pressed function key. For the convenience of understanding, the function keys 10a to 10c shown in FIG. 3 are directly connected with the control unit 14 though directly-linked signal lines, but it is noted that the scan signal generated via many interacted scan lines may act like the control signal, wherein the control unit 14 is able to determine a specific function key is pressed via the scan signal.

As the embodiment shown in FIG. 3, the control unit 14 connects the function keys 10a to 10c with a set of indicator 16a to 16c one by one. The control unit 14 may make the Caps Lock key 10a correspond to indicator 16a, the Num Lock key 10b correspond to indicator 16b, and Scroll Lock key 10c correspond to indicator 60c. Each indicator 16a to 16c electronically connects to two I/O pins of the control unit 14, as 140a and 142a, 140b and 142b, and 140c and 142c shown in FIG. 3, for receiving the directional indication current formed by the triggered indication voltage and for driving the indicator 16a to 16c to change the indication faces.

The case of the cordless keyboard 3 has multiple windows 32, each of which is overlapped with the surface of one of the indicating units 162. In other words, users may see the indication face of the indicating unit 162 through the window 32 of the cordless keyboard 3, and recognize whether the input mode controlled by the corresponding function key is enabled.

Please refer to FIGS. 2 and 3 for detailed descriptions. Take the Caps Lock key 10a shown in FIG. 3 as an example, assume that the indication face corresponding to the enablement of capital locking function is the first indication face 1622 shown in FIG. 2, and the disablement of capital locking function is corresponding to the second indication function 1624 shown in FIG. 2. When the control unit 14 determines that the Caps Lock key is pressed and the capital locking function is enabled, the indication voltage is triggered to form an indication current, such as a forward current. The driving unit 160 drives the indicating unit 162 synchronously to rotate then, till the brake 164 is obstructed by one edge of the window 32. Hence, users of the cordless keyboard 3 may recognize the enablement of the capital locking function via the indication of the indicator 16a through the window 32 corresponding to the indicator 16a.

On the other hand, when the control unit 14 receives a new control signal from the Caps Lock key 10a, the control unit 14 may identify that the capital locking function is disabled and the input mode is changed. The control unit 14 may generate another indication voltage to form a new indication current, such as a reverse current. The driving unit 160 is then rotating reversely and drives the indication unit 162 to rotate as well. The indication unit 162 may then turn from the first face 1622 to the second face 1624, showing the second face 1624 through the window 32. Users may be informed of the disablement of the capital locking function.

Though the above-mentioned example describes only about the operation of the Caps Lock key 10a, people skilled in the art would be able to utilize the control unit to control the indicator corresponding to other function keys like the Num Lock key 10b and the Scroll Lock key 10c according to the afore-mentioned approaches.

Embodiment of Input Device—Indicating Low Battery

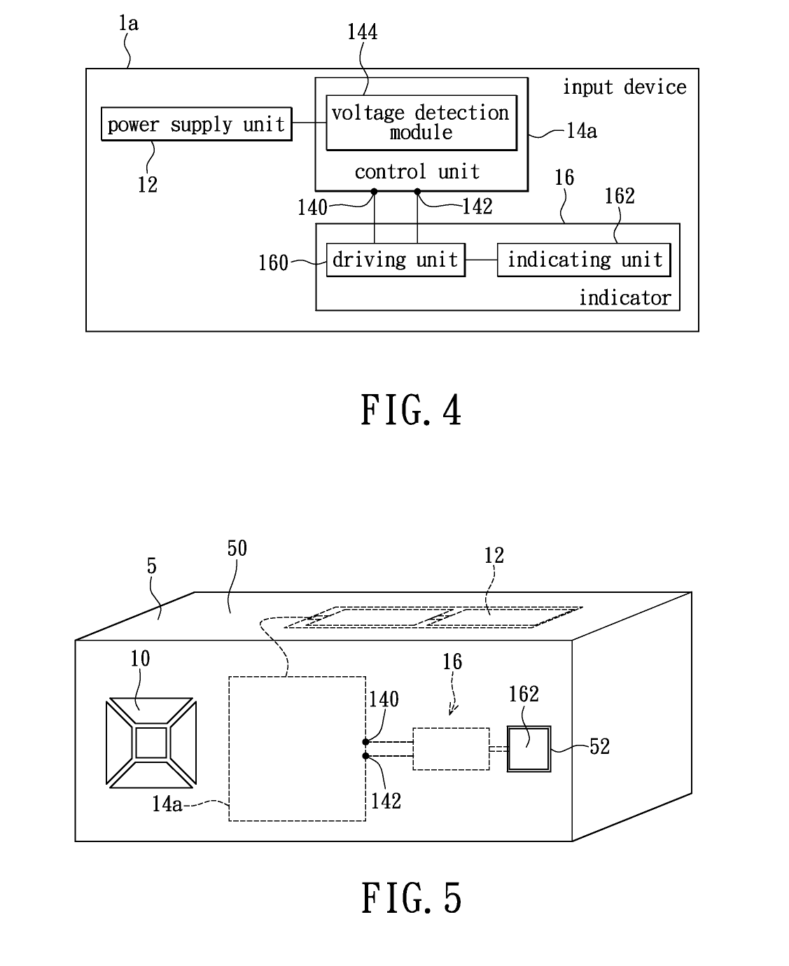

FIG. 4 shows a block diagram of input device according to another embodiment of the present invention. The input device 1a of the present embodiment includes a power supply unit 12, a control unit 14a, and an indicator 16. The control unit 14a further includes I/O pins 140 and 142, and a voltage detection module 144. The indicator 16 further includes a driving unit 160 and an indicating unit 162. The control unit 14a is electronically connected with the power supply unit 12, and is electronically connected with the driving unit 160 via the I/O pins 140 and 142. The indicator 16 of the present embodiment may specifically be a motor or an indication ring as shown in FIG. 2 where reference may be made to in view of the detailed structures of the indicator 16.

The power supply unit 12 may be a battery. The voltage detection module 144 of the control unit 14a is used to detect voltages of the power supply unit 12. The voltage detection module 144 may compare a preset voltage value with a detected voltage value of the battery, and generates a control signal to trigger an indication voltage to form a directional indication current when the detected voltage value is lower than the preset voltage value. It is determined that the power of the input device 1a is going to be exhausted when the detected voltage value is lower than the preset voltage value. The driving unit 160 and the indication unit 162 may rotate synchronously in accordance with the direction of the indication current, in order to change the indication faces of the indicating unit 162 and inform the user of a low battery state.

The surface of the indicating unit 162 may be divided into multiple indication faces by covering different colors, which correspond to a normal state and the low battery state respectively. For example, when receiving the control signal generated by the voltage detection module 144, the control unit 14a may determine that the input device 1a is in the low battery state and thus form a forward current to trigger the driving unit 160 rotate toward the position of a first direction, which cause the indicating unit 162 rotate to the first indication face 1622 as well. Contrarily, when the voltages of the power supply unit 12 are not lower than the preset voltage value, the control unit 14a may then generate another indication voltage to trigger a reverse current based on the detection result of the voltage detection module 144. The driving unit 160 may then rotate toward a second direction opposite to the first direction according to the reverse current, and make the indicating unit 162 rotate from the first indication face 1622 indicating the low battery state to the second indication face 1624 indicating the normal state.

Embodiment of an Input Device—Presentation Controller

FIG. 5 shows a perspective diagram of an input device according to another embodiment of the present invention, which is used to describe the input device via a specific example. The input device in the present embodiment may be a presentation controller 5, such as a wireless pan-shaped presentation device. The presentation controller 5 includes a function key 10 for switching slides and for playing or pausing media files, a power supply unit 12 for supplying power, a control unit 14a, and an indicator 16 for indicating the battery state of the presentation controller 5. The function key 10, the power supply unit 12, the indicator 16 are electronically connected with the control unit 14, respectively. The indicator 16 may be a motor or an indication ring as shown in FIG. 2.

As shown in FIG. 5, the presentation controller 5 further includes a window 52 set on the surface of the case 50 of the presentation controller 5. The function key 10 is also configured on the surface of the case 50, and the power supply unit 12, the control unit 14a, and the indicator 16 may be embedded inside the case 50. The surface of the indication unit 162 fronts the window 52 of the presentation controller 5, so as to reveal the indication faces through the window 52.

The power supply unit 12 may be a battery, wherein a voltage detection module (not shown in FIG. 5) of the control unit 14a is used to detect the voltages of the battery. When the detected voltage value detected by the voltage detection module is lower than a preset voltage value, the voltage detection module generates a control signal so that the control unit 14a may trigger the indication voltage to form the indication current, such as a forward current, and transmit the current to the indicator 16. The driving unit 160 (refer to FIG. 2) of the indicator 16 may rotate in accordance with the direction of the indication current, and promote the indication unit 162 to rotate synchronously. Hence the appropriate indication face of the indication unit 162 may be turned to front the window 52 based on the direction of the indication current. The user may then be informed of the low battery state through seeing the indication face, such as the first indication face 1622 covered with bright color, fronting the window 52.

When the battery voltages turn from the low battery state to the normal state, the indicator 16 may rotate according to a reverse current from the control unit 14a, and the indication face fronting the window 52 would turn to the second indication face 1624. The user may then understand that the battery is in the normal state.

The descriptions of driving unit 160 and the indication unit 162 of the indicator 16, and the operation of the indicator 16 are introduced in the paragraphs corresponding to FIG. 2. Thus the details of said units or component would be omitted here.

Embodiment of Another Indicator

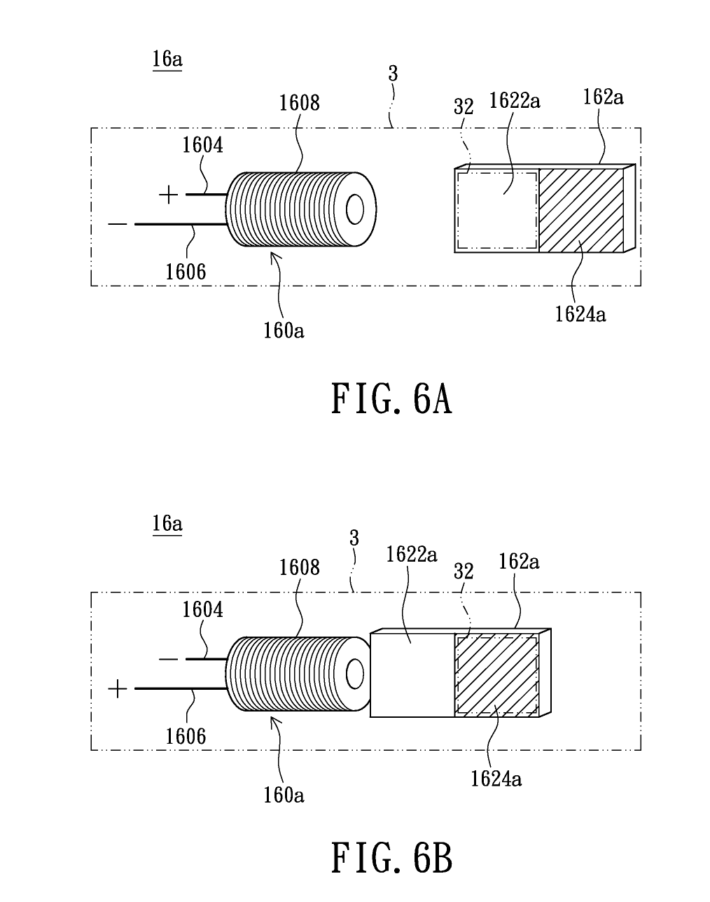

The afore-mentioned embodiments disclose an indicator 16 configured by a motor or an indication ring shown in FIG. 2 to point out different input modes or battery voltage states of an input device. Here FIGS. 6A and 6B illustrate an indicator that could be cooperated with the afore-mentioned various input devices (e.g. the cordless keyboard or the presentation controller, and so on) according to another embodiment.

The indicator 16a shown in FIG. 6A includes a driving unit 160a and an indicating unit 162a, and may be embedded inside the case of the cordless keyboard 3. The driving unit 160a in the present embodiment includes a electromagnetic coil 1608 and power cables 1604 and 1606, while the indicating unit 162a may be a bar-shaped permanent magnet having a north magnetic pole (N pole) and a south magnetic pole (S pole). The first indication face 1622a and the second indication face 1624a are corresponding to the two magnetic poles of the permanent magnet respectively. For example, the first indication face 1622a corresponds to the N pole area of the magnet, and the second indication face 1624a corresponds to the S pole area of the magnet. The magnetic orientation of the electromagnetic coil 1608 is parallel with the first indication face 1622a and the second indication face 1624a.

The indicator 16a in the present embodiment utilizes the changes of the directions of the indication current to alter the directions of the magnetic field of the electromagnetic coil 1408, so as to attract or repel the permanent magnet due to the polar attraction or the polar repulsion, respectively, and resulting the first indication face 1622a and the second indication face 1624a in moving to front the window 32 of the cordless keyboard 3 in turn.

More specifically speaking, please refer to FIG. 6A, when the function key 10 being pressed and the control signal being generated (reference is made to FIG. 1 and related descriptions) or the voltages of the power supply unit 12 being detected and the control signal being generated by the voltage detection unit 144 (reference is made to FIG. 4 and related descriptions), the control unit 14 or 14a triggers the indication voltage and forms the indication current, such as a forward current. The electromagnetic coil 1608 produces a magnetic field pointing to the north pole according to the forward current, and then repels the first indication face 1622a closing to the coil 1608 to the position of the window 32.

Reference is now made to FIG. 6B, when the function key 10 being pressed again or the voltages of the power supply unit 12 being recharged to the normal state, the control unit 14 or 14a generates another indication voltage to form a new indication current, such as a reverse current. The electromagnetic coil 1608 produces a magnetic field pointing to the south pole according to the reverse current, and then attracts the first indication face 1622a corresponding to the N pole, resulting in the second indication face 1624a moving to front the window 32.

The correspondence between the poles and the indication faces are exemplarily presented in the above-mentioned description. In other examples, it may be the S pole corresponding to the first indication face 1622a and the N pole corresponding to the second indication face 1624a. Meanwhile, the correspondence between the indication currents and the indication faces may be exchanged as well. The main point is that the control unit 14 or 14a may generate an appropriate indication current based on the input modes or the power state, and then the driving unit 160a may be triggered to drive the indicating unit 162a switching to a proper indication face.

Embodiment of Still Another Indicator

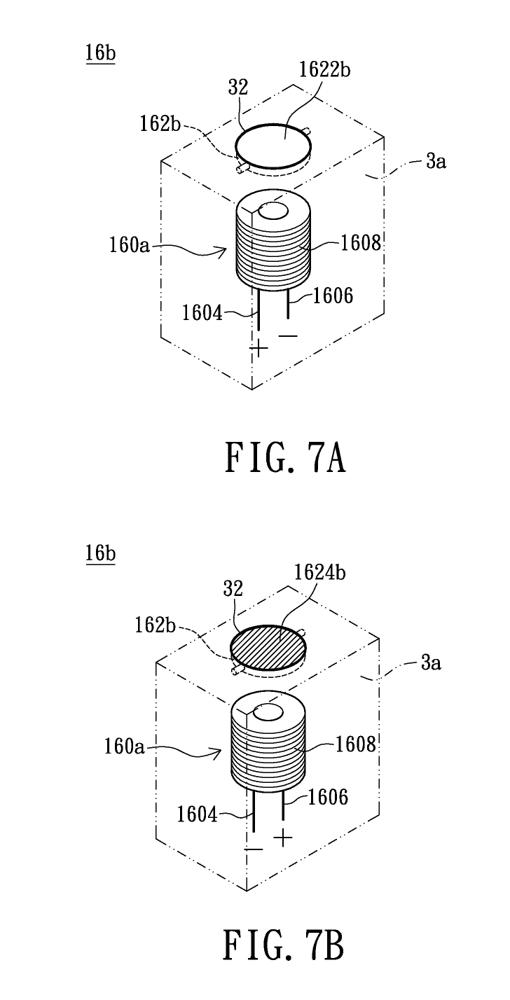

Please refer to FIGS. 7A and 7B, which illustrate a perspective diagram of an indicator of another embodiment. The indicator 16b shown in FIGS. 7A and 7B is similar to the indicator 16a shown in FIGS. 6A and 6B, which is embedded inside the case of the cordless keyboard 3a. The indicator 16b includes a driving unit 160a having an electromagnetic coil 1608 and power cables 1604 and 1606 for receiving power from the control unit, and an indicating unit 162b composed of a permanent magnet.

The permanent magnet of the present embodiment may be a flat plate magnet having two flat indication faces corresponding to a N pole and a S pole respectively, which is different from the magnet shown in FIGS. 6A and 6B in shape. In the present embodiment, it is assumed that the first indication face 1622b (refer to FIG. 7A) is corresponding to the N pole while the second indication face (refer to FIG. 7B) is corresponding to the S pole.

As shown in FIGS. 7A and 7B, the indicating unit 162b is placed between the electromagnetic coil 1608 and the window 32 of the cordless keyboard 3a. The first indication face 1622b and the second indication face 1624b are substantially perpendicular to the magnetic orientation of the electromagnetic coil 1608. The permanent magnet is pivotably set on the cordless keyboard 3a, when the electromagnetic coil 1608 receives the indication current from the control unit (not shown in FIG. 7A or 7B) and changes the pole of the coil 1608, the indication face corresponding to the same pole of the coil 1608 would be turned to front the window 43 due to polar repulsion.

Assume that the first indication face 1622b corresponding to N pole is configured to indicate a low battery state or the enablement of a specific input mode. Please refer to FIG. 7A, when the control unit determines that the input device is in the low battery state or the specific input mode is enabled, the control unit could output the indication current that makes the electromagnetic coil 1608 generate the N pole toward the indicating unit 162b, therefore the first indication face 1622b would be turned to front the window 32 due to the polar repulsion, meanwhile, the second indication face 1624b would be turned to front the coil 1608. Therefore, the user would be able to see the first indication face 1622b through the window 32, and then recognize the low battery state or the enablement of the specific input mode.

On the contrary, please refer to FIG. 7B, when the input mode is disabled or the low battery state dismissed, the indication current the control unit output makes the coil 1608 generate the S pole toward the indicating unit 162b. Consequently, the second indication face 1624b originally fronting the coil 1608 would be turned to front the window 32 instead. Hence, the user may see the second indication face 1624b through the window 32, and recognize the disablement of the input mode or the relief of low battery.

Possible Effects Reached Via The Embodiments

According to the above-mentioned embodiments, the indicator may provide useful and power-saving indication or warning for various kinds of input devices. The indicator needs only two pins from the control unit to be connected with the input device, which may save a lot of manufacturing cost and is easy to produce. Therefore, the indications depicted in the above-mentioned embodiments are suitable for input devices need to provide information about specific functions or power status, especially for input devices with power-saving requirements, such as cordless keyboards, cordless computer mouses, or other wireless controllers powered by batteries.

The input device according to the embodiments of the present invention, there is no need to provide power for the indicator except at the moment the indication faces need to be changed or switched. When the changing or switching of the indication faces complete, for example after driven by the motor to rotate or after the bar magnet moving or the flat plate magnet turning due to magnet attraction or repulsion, the indicator could stop receiving power. Since the time for changing or switching the indication faces are quite short, the amount of power consumed during changing or switching would be small as well, and a lot of power could be saved while indication or warning keeps working. Hence, the indicator may be very helpful for retaining usable time of input devices.

Furthermore, the indicator utilizes different indication faces to show different information of the input device such as the enablement or disablement of specific input mode, allowing users to understand the state of the input device through seeing colors shown in the window. Users may receive various necessary information via the indicators disclosed in the present invention without display screens, such as knowing the low battery state of wireless input devices without the need of LED screens. Therefore the cost of installing a display screen on an input device is also saved.

Meanwhile, it would need only two pins of the control unit of the input device to connect with the driving unit of the indicator, wherein the control unit may then control the driving unit to rotate or change magnetic pole by changing the directions of the indication current, and make the indicator show appropriate indication information accordingly. The circuit design for the control unit is simple and the cost of manufacturing of the controller is low.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims

What is claimed is:

1. An input device, comprising:
a control unit, configured for receiving a control signal, and triggering an indication voltage according to the control signal to output an indication current; and
an indicator, including:
an indicating unit, having multiple indication faces; and
a driving unit, electronically connected with the control unit and coupled with the indicating unit, and driving the indicating unit to switch to one of the indication faces based on a direction of the indication current.

2. The input device according to claim 1, further comprising:
a function key, electronically connected with the control unit, wherein the function key is used for switching an input mode of the input device, and generating the control signal to the control unit in accordance with the input mode.

3. The input device according to claim 1, further comprising:
a power supply unit, electronically connected with the control unit, wherein the control unit further includes a voltage detection module for detecting voltages of the power supply unit, and the voltage detection module generates the control signal when the voltages of the power supply unit being lower than a preset voltage value.

4. The input device according to claim 1, wherein the driving unit is a motor including a rotatable shaft, the indicating unit is a indication ring connecting to the rotatable shaft, and the motor, rotating in accordance with the direction of the indication current, drives the indication ring to switch among the multiple indication faces.

5. The input device according to claim 4, wherein the indicator further comprises:
a brake, located on the driving unit or the indicating unit corresponding to a border shared by the multiple indication faces, used for stopping the driving unit from rotating.

6. The input device according to claim 1, wherein the driving unit is a electromagnetic coil switching between a north magnetic pole and a south magnetic pole according to the direction of the indication current, used for driving the indicating unit to switch among the multiple indication faces.

7. The input device according to claim 6, wherein the indicating unit is a permanent magnet.

8. The input device according to claim 7, wherein the multiple indication faces of the permanent magnet respectively correspond to the north magnetic pole and the south magnetic pole of the permanent magnet, the multiple indication faces vertically corresponding to a magnetic orientation of the electromagnetic coil, and the indication faces being switched via the permanent magnet rotating in accordance with the corresponding magnetic poles.

9. The input device according to claim 7, wherein the multiple indication faces of the permanent magnet respectively correspond to the north magnetic pole and the south magnetic pole of the permanent magnet, the multiple indication faces and a magnetic orientation of the electromagnetic coil being in parallel, and the indication faces being switched via the permanent magnet moving toward to or away from the indication unit in accordance with the corresponding magnetic poles.

10. The input device according to claim 4, wherein the indication current is a forward current or a reverse current, and the multiple indication faces include a first surface and a second surface.

11. The input device according to claim 6, wherein the indication current is a forward current or a reverse current, and the multiple indication faces include a first surface and a second surface.

12. The input device according to claim 1, further comprising:
a window, configured on a surface of the input device;
wherein at least one of the indication faces of the indicating unit fronts the window.

13. The input device according to claim 1, wherein the control unit further comprises:
a plurality of I/O pins, electronically connected with the driving unit separately;
wherein the control unit outputs the indication current to the driving unit based on the reception of the control signal.

14. An indicator of an input device, wherein the input device includes a control unit for triggering an indication voltage and outputting an indication current, comprising:
an indicating unit, having multiple indication faces; and
a driving unit, electronically connected with the control unit and coupled with the indication unit, and driving the indicating unit to switch to one of the indication faces based on a direction of the indication direction.

15. The indicator according to claim 14, wherein the driving unit is a motor including a rotatable shaft, the indicating unit is a indication ring or a turntable connecting to the rotatable shaft, and the motor, rotating in accordance with the direction of the indication current, drives the indication ring or the turntable to switch among the multiple indication faces.

16. The indicator according to claim 15, further comprising:
a brake, located on the driving unit or the indicating unit corresponding to a border shared by the multiple indication faces, used for stopping the driving unit from rotating.

17. The indicator according to claim 14, wherein the driving unit is a electromagnetic coil, the indication unit is a permanent magnet, and the multiple indication faces of the permanent magnet respectively correspond to a north magnetic pole and a south magnetic pole of the permanent magnet, the multiple indication faces vertically corresponding to a magnetic orientation of the electromagnetic coil, and the indication faces being switched via the permanent magnet rotating in accordance with the corresponding magnetic poles.

18. The indicator according to claim 14, wherein the driving unit is a electromagnetic coil, the indication unit is a permanent magnet, and the multiple indication faces of the permanent magnet respectively correspond to a north magnetic pole and a south magnetic pole of the permanent magnet, the multiple indication faces and a magnetic orientation of the electromagnetic coil being in parallel, and the indication faces being switched via the permanent magnet moving toward to or away from the indication unit in accordance with the corresponding magnetic poles.
